(19) United States
(12) Patent Application Publication
(10) Pub. No.: US 2003/0012247 A1
(43) Pub. Date: Jan. 16, 2003

(54) Folded-resonator multimode laser with periodic gain-medium

(76) Inventor: Juan L. Chilla, Sunnyvale, CA (US)

Correspondence Address: STALLMAN & POLLOCK LLP, Suite 290, 121 Spear Street, San Francisco, CA, 94105, US

(21) Appl. No.: 09/902,982

(22) Filed: Jul. 11, 2001

(51) Int. Cl. H01S 3/091; H01S 3/092; H01S 3/081; H01S 3/08

(52) U.S. Cl. 372/93; 372/70; 372/96

(57) ABSTRACT

A laser includes a laser resonator having a longitudinal axis and a monolithic layer structure having a mirror in contact with a semiconductor multilayer surface-emitting gain-structure. The gain-structure includes a plurality of active layers spaced apart by spacer layers. The longitudinal axis of the laser resonator is folded at an angle by the mirror structure of the monolithic layer structure, with the gain-structure included in the laser resonator. An arrangement is provided for energizing the gain-structure and thereby generating laser radiation in the laser resonator. The fold angle of the resonator axis is selected such that the laser radiation is generated in multiple axial modes. The energizing arrangement may be electrical or optical.

### TECHNICAL FIELD OF THE INVENTION

The present invention relates in general to lasers including a periodic gain-medium. It relates in particular to an external-resonator, semiconductor laser having a surface-emitting gain-structure in contact with a mirror that folds the external-resonator at a predetermined angle.

### DESCRIPTION OF BACKGROUND ART

External-resonator (external-cavity), surface-emitting semiconductor lasers are capable of providing a high-quality monochromatic beam of optical radiation in a wide range of wavelengths. The wavelength of fundamental radiation generated by such a laser is determined, inter alia, by the composition of active layers in multilayer semiconductor gain-structure arranged to provide optical gain when energized. The gain-structure may be energized by either electrical or optical pumping. Examples of optically pumped external-cavity, surface-emitting semiconductor lasers are described in U.S. Pat. No. 5,991,318 and U.S. Pat. No. 6,097,742, both incorporated by reference. Examples of electrically pumped external-cavity, surface-emitting semiconductor lasers are described in PCT publication WO98/43329.

Within certain wavelength ranges characteristic of the general composition of the semiconductor material of the active layers, i.e., the combination of elements in the material, the wavelength may be essentially continuously varied by adjusting the relative amounts of elements in the material. Ranges of available wavelengths may be extended by including one or more optically-nonlinear crystals inside or outside the laser resonator to convert the fundamental wavelength to another wavelength, for example, the second, third, or fourth harmonic wavelength.

Active layers in a semiconductor gain-structure are separated by spacer layers. Spacer layers are arranged such that the active layers are optically spaced apart by about one-half wavelength at the fundamental wavelength, and such that the active layers or aligned with antinodes of a standing wave of the fundamental wavelength generated in the resonator. An external-resonator having such a gain-structure located at one end thereof, and configured to allow only as single transverse mode, inherently delivers radiation in a single axial (longitudinal) mode. Running in a single axial mode provides for a high-quality beam that can be focused into a very small (essentially diffraction-limited) spot. This can be useful for focusing the laser radiation into an optical fiber for transmission therealong, for example, in telecommunication applications.

A problem has been discovered, however, in that when radiation from an external-cavity semiconductor laser is focused into an optical fiber for transmission thereby, a portion of the radiation is reflected, (fed) back from the delivery end of the optical fiber into the laser resonator. Feedback can also occur from optical elements located downstream of the optical fiber, for example, multiplexers, demultiplexers, beamsplitters, combiners and the like. A result of this is that the oscillation of the resonator is caused to repeatedly switch from oscillating in one possible mode to oscillating in another mode. This causes fluctuation or mode noise in the output of the external-cavity semiconductor laser. Accordingly, there is a need for an external-cavity semiconductor laser arrangement which can deliver radiation in multiple axial modes for avoiding this feedback problem.

### SUMMARY OF THE INVENTION

In one aspect, the inventive laser comprises a monolithic layer structure including a mirror structure in contact with a semiconductor multilayer surface-emitting gain-structure. The gain-structure includes a plurality of active layers spaced apart by spacer layers. The laser includes a laser resonant cavity (laser resonator) terminated by first and second mirrors. The longitudinal axis of the laser resonator is folded at an angle by the mirror structure of the monolithic layer structure, with the gain-structure of the monolithic layer structure included in the laser resonator. An arrangement is provided for energizing the gain-structure and thereby generating laser radiation in the laser resonator. The fold angle of the resonator axis is selected such that the laser radiation is generated in multiple axial modes.

The gain-structure may be electrically or optically energized. For a given resonator, the fold angle for providing multiple-axial-mode operation has been found to lie in a relatively-narrow critical range. At fold angles less than the lower limit of the critical range and higher than the high limit of the critical range, the laser will operate only in a single axial mode. By way of example, in a resonator in which the monolithic layer structure is located at about a midpoint between the mirrors, the fold angle is preferably selected within a range between about 7.0 and 10.0 degrees (full angle).

### BRIEF DESCRIPTION OF THE DRAWINGS

The accompanying drawings, which are incorporated in and constitute a part of the specification, schematically illustrate a preferred embodiment of the present invention, and together with the general description given above and a detailed description of the preferred embodiment given below, serve to explain the principles of the invention.

FIG. 1 schematically illustrates a prior art, single mode, optically pumped external cavity, surface-emitting semiconductor laser (OPS laser) including a quantum well gain-structure arranged to deliver radiation into an optical fiber.

FIG. 2 schematically illustrates one preferred embodiment of a multimode, folded resonator, external cavity, surface-emitting semiconductor laser in accordance with the present invention including an optically pumped semiconductor gain-structure arranged to deliver radiation into an optical fiber.

FIG. 3 is perspective view schematically illustrating interaction of an oscillation mode with the gain-structure in the OPS laser of FIG. 1.

FIG. 4 is a perspective view schematically illustrating interaction of a single oscillation mode with the gain-structure in the laser of FIG. 2.

FIG. 5 is a perspective view schematically illustrating interaction of multiple oscillation modes with the gain-structure in the laser of FIG. 2.

FIG. 6 schematically illustrates another embodiment of a folded resonator, multimode, external-cavity, surface-emitting semiconductor laser in accordance with the present invention including two optically pumped semiconductor gain-structures.

FIG. 7 schematically illustrates yet another preferred embodiment of a folded resonator, multimode, external cavity, surface-emitting semiconductor laser in accordance with present invention including an electrically pumped semiconductor gain-structure.

FIG. 8 schematically illustrates still another embodiment of a folded resonator, multimode, external cavity, surface-emitting semiconductor laser in accordance with the present invention including an optically pumped semiconductor gain-structure for generating fundamental radiation, and an optically-nonlinear crystal for doubling the frequency of the fundamental radiation.

### DETAILED DESCRIPTION OF THE INVENTION

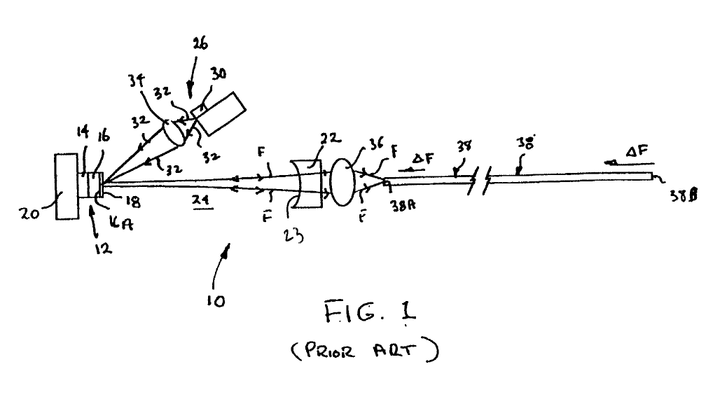

Before presenting a detailed description of the external cavity surface-emitting semiconductor laser in accordance with present invention, it is useful to briefly review the arrangement of a prior-art single mode external-cavity surface-emitting semiconductor laser delivering radiation into an optical fiber. Turning to the drawings, wherein like components are designated by like reference numerals, FIG. 1 depicts a prior art OPS laser 10 arranged to deliver fundamental radiation into a single axial mode. Laser 10 includes a monolithic multilayer structure (OPS structure) 12 including a Bragg-mirror structure 14, and surface-emitting semiconductor gain-structure 16 including a plurality of active or quantum well layers (not shown) spaced apart by spacer layers (not shown). An optional antireflection coating 18 is deposited on emitting surface 16A of gain-structure 16. OPS structure 12 is preferably in thermal contact with a substrate or heat sink 20.

An external mirror 22 having a partially-transmitting reflective coating 23 thereon is spaced apart from, and aligned with, Bragg-mirror structure 14 of OPS structure 12 to define the laser resonator 24. Gain-structure 16 of OPS structure 12 is thereby incorporated in laser resonator 24.

And optical pump radiation source 26 is arranged to deliver pump radiation to gain-structure 16 of OPS structure 12, via emitting surface 16A thereof, for generating laser radiation in laser resonator 24. Fundamental radiation so generated, circulates in laser resonator 24 as indicated by rays F. Pump radiation source 26 includes an edge-emitting semiconductor diode-laser 30 or an array of such lasers. Pump radiation 32 from diode-laser 30 is focused by a lens 34 onto gain-structure 16 of OPS structure 12.

Circulating radiation F is coupled out of laser resonator 24 via partially-transmitting mirror 22 as output radiation, and is focused by a lens 36 into an input end 38A of optical fiber 38 for delivery to a site or apparatus where it will be used.

As discussed above, focusing single-axial-mode radiation from a laser such as laser 10 into an optical fiber has been found to perturb the otherwise quiet, true single-mode operation of the OPS laser. This is due, in particular, to reflection of a portion ΔF of radiation F from exit end 38B of optical fiber 38. The phase of radiation ΔF relative to the standing waves (mode) of resonator 24 varies randomly. Accordingly, interaction of the reflected radiation (feedback) with the operating mode varies randomly, causing the above-discussed mode hopping effects and attendant mode noise. As noted above, reflections from other sources can cause mode-hopping. Reflection from the exit end of the optical fiber is particularly problematical because this reflection is mode-matched to laser resonator 24. In the arrangement of the present invention, effects of feedback from optical fiber 48, and these other effects, are minimized by providing an external-cavity, surface-emitting semiconductor laser which delivers radiation in multiple axial modes.

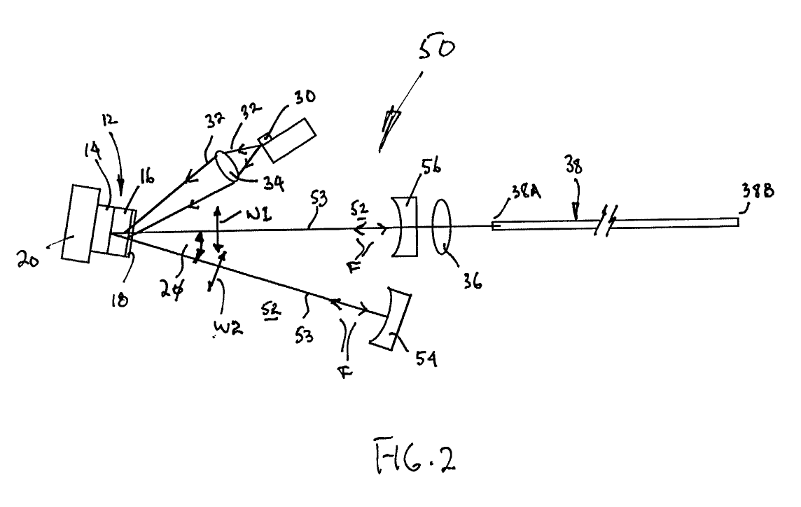

Referring now to FIG. 2, one preferred optically pumped, external-cavity, surface-emitting semiconductor laser (OPS laser) 50 for delivering radiation in multiple axial modes includes a folded resonator 52 terminated by concave mirrors 54 and 56. Mirror 54 is a maximally reflecting mirror. Resonator 52, i.e., longitudinal axis 53 of resonator 52, is folded at an angle 2Φ (twice the angle of incidence of circulating radiation on the mirror) by a Bragg-mirror structure 14 of an OPS structure 12. Surmounting Bragg-mirror structure 14 is a semiconductor gain-structure 16 including a plurality of active or quantum-well layers (not shown) spaced apart by spacer layers (not shown) as discussed above with reference to laser 10. An optional antireflection coating 18 is deposited on emitting surface 16A of gain-structure 16. Optical pumping arrangements and optical arrangements for focusing output radiation from resonator 52 into optical fiber 38 are as described above for laser 10. Only the general direction of circulating radiation F along axis 53 of resonator 52 is depicted in FIG. 2, for simplicity of illustration. It has been determined experimentally that for an oscillation wavelength of about 970 nm, and with gain structure 16 located about centrally in the resonator, there is a critical range of fold angles between about 7 degrees (7°) and 10° in which multimode operation can occur. At angles greater than 10° or less than about 7°, the resonator operates in a single axial mode. The upper limit of the range for multimode operation is believed to increase with increasing operating power (pump power) of the resonator. Without being limited to a particular hypothesis, one possible explanation for this property of resonator 52 is set forth below.

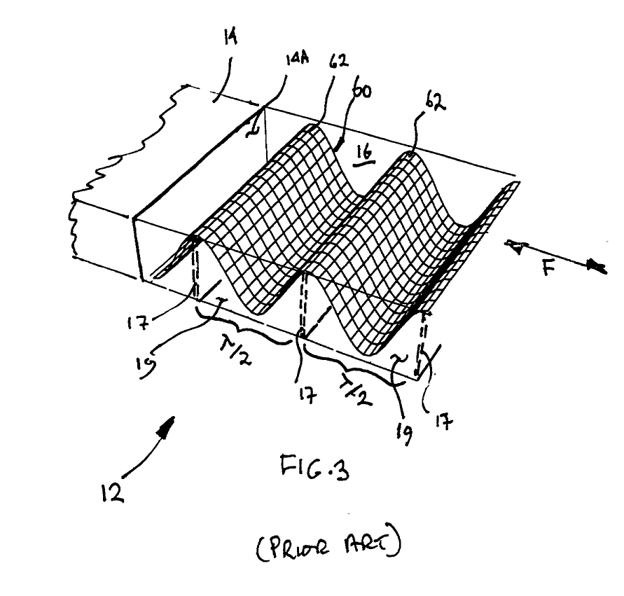

In FIG. 3, the intensity of a portion of a standing wave (single operating mode) in laser 10 of FIG. 1, in gain-structure 16, near an interface 48 between Bragg mirror structure 14 and gain-structure 16, is depicted as a sinusoidal (sine squared) surface 16 having a node at interface 14A. For simplicity of illustration, antireflection layer 18 is omitted, and the usual, transverse intensity distribution across the beam due to the optical configuration of the resonator is not taken into account.

The standing wave intensity 16 has a plurality of intensity maxima (antinodes) 62 spaced apart by an optical distance λ_{N}/2, where λ_{N} is the wavelength of the operating mode (the nominal operating wavelength of the laser). A possible mode or standing wave may be generated at any wavelength for which resonator 24 has an optical length of an integer number of half wavelengths. By way of example, given a nominal operating wavelength of 970 nm, a resonator having a length of 10.0 centimeters (cm) will accommodate a standing wave having tens of thousands of antinodes. Absent any constraint to the contrary, such a resonator would support simultaneous oscillation of a plurality of modes having wavelengths spaced apart by a fraction of a nanometer, provided those wavelengths were within the gain-bandwidth of gain-structure 16. This gain-bandwidth would typically be about 20 nm.

Continuing with reference to FIG. 3, it can be seen that in gain-structure 16, quantum-well layers 17, in which electrical carriers recombine to provide optical gain, are spaced apart by an optical distance λ_{N}/2 and are positioned to coincide with antinodes 62 of the standing wave 60. Quantum-well layers 17 are spaced apart by one or more spacer layers indicated collectively by reference numeral 19. Gain-structure 16 maybe generally described as a periodic gain-medium in which optical gain occurs only at a plurality of longitudinally spaced apart gain-regions between which no gain occurs. Typically, in a surface-emitting semiconductor gain-structure such a structure 16, quantum-well layers (gain-regions) 16 have a thickness between about 5.0 and 15.0 nm, which is only a small fraction of the spacing therebetween.

As interface 14A represents and end of resonator 24, all possible operating modes of the resonator will have a node at interface 14A. Within the thickness (length) of a gain-structure having even as many as 15 quantum-well layers, antinodes 62 of the range of possible oscillating modes allowed by the gain-bandwidth of the gain-structure will be separated, at most, by a distance comparable with the quantum-well layer thickness. Accordingly, that mode which is the first to spontaneously oscillate (lase) on pumping (energizing) gain-structure 16 will extract most, if not all, optical gain from quantum well layers 17. This will leave insufficient gain to support lasing of any other possible operating modes. Accordingly, the first mode to lase will continue to lase exclusively in that single operating mode, absent some external perturbation of resonator 24. Above-described feedback from optical fiber 38 can cause such a perturbation. This perturbation causes laser resonator 24 to switch unpredictably from one single operating mode to another, resulting in mode-hopping noise.

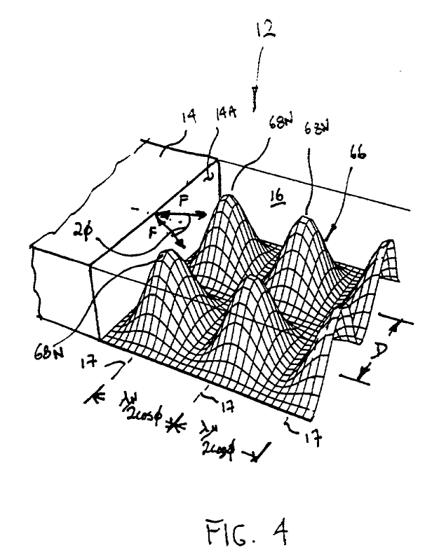

Referring now to FIG. 4 and again to FIG. 2, the intensity of a portion of a standing wave (single operating mode) in laser 50 of FIG. 2, in gain-structure 16, near an interface 14 between Bragg-mirror structure 14 and gain-structure 16 is depicted. For simplicity of illustration again, antireflection layer 18 is omitted, and the usual, transverse intensity distribution across the beam due to the optical configuration of the resonator is not taken into account. Quantum-well layers are not explicitly shown in FIG. 4 but the positions of the quantum-well layers are indicated by dotted line 17.

Interference of wavefronts at an angle to each other, indicated in FIG. 2 by arrows W1 and W2, provide that the standing wave intensity in gain-structure 16 of any single mode takes on a complex “modulated” form represented in FIG. 4 by surface 66. Intensity peaks 68N (the suffix “N” here designating a particular mode number) of surface 66 align perpendicular and parallel to interface 14A.

The optical distance separating the peaks in the direction perpendicular to the gain structure is λ_{N}/2 cos Φ. Within the critical incidence angle range of the present invention, the spacing is a slowly varying function of angle Φ and remains sufficiently close to λ_{N}/2 that approximate alignment of the peaks with the quantum well layers is substantially maintained. In the direction parallel to the gain-structure, the intensity peaks are separated by a distance D which is equal to λ_{N}/2 sin Φ. Within the critical incidence angle range of the present invention, the spacing is a rapidly varying function of angle Φ and changes by about a factor of about two through the range. The lateral or parallel position of the peaks of one possible oscillation mode relative to the other is determined by the relative wavelengths of the oscillation modes.

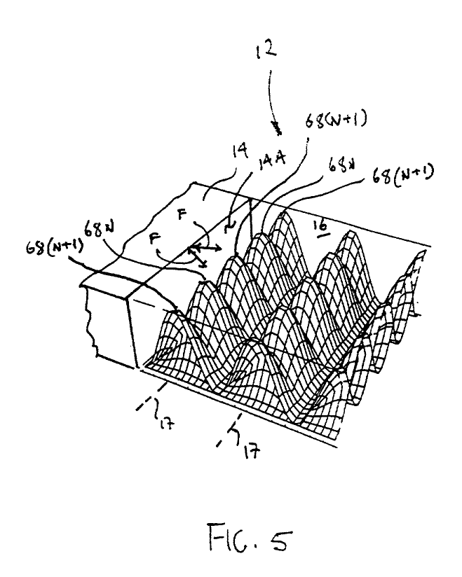

Within the critical range of fold angle 2Φ, for any given mode, there is a parallel spacing of intensity peaks that causes the mode to extract less than all of the optical gain available in the quantum-well layer with which the peaks are aligned. This provides that at least one other possible mode having standing wave intensity peaks 68 of surface 66 occurring between those of that given mode can extract the unused gain from the quantum well and oscillate simultaneously. This condition is depicted in FIG. 5, wherein intensity peaks 68N of the mode having N antinodes in the length of the resonator occur between intensity peaks 68(N+1) of a next possible mode having N+1 antinodes in the length of the resonator. If the spacing of peaks 68N is appropriate, intensity peaks of the other possible modes (N+2, N+3 . . . ) falling between those of the N and N+1 modes may also extract gain from the quantum-well layers, thereby allowing simultaneous oscillation of a plurality of axial modes. For an oscillation wavelength of about 980 nm, the separation D between peaks (FIG. 4) is between about 6.0 and 8.0 micrometers (m) when the fold angle is in the critical angle range.

It should be noted here that the above-presented explanation is based on a phase relationship between oscillating modes that exists when gain structure 16 is located centrally in a resonator. Those skilled in the art will recognize that this phase relationship will vary with the position of the gain-structure in the resonator. It can also be expected that the critical angle range may vary somewhat with the position of the gain-structure resonator. From the description presented above, however, one skilled in the art could readily determine by experiment, an appropriate critical angle range for a different location of the gain-structure in the resonator.

It is believed that the restoration of single mode operation at values of angle 2Φ greater than the critical range is due to the lateral spacing between intensity peaks of any single mode becoming comparable with the diffusion length of carriers in the quantum-well layers. This allows any single possible operating mode to extract all of the available gain from quantum-well layers in the gain-medium. Single mode operation at values of less than the critical angle range is believed to be due to lateral separation of the intensity peaks being so great that, within the mode width of the resonator at the gain-structure, single intensity peaks of a particular oscillation mode, aligned with the corresponding quantum-well layer, can extract all of the gain from that layer, thereby preventing any other mode from lasing.

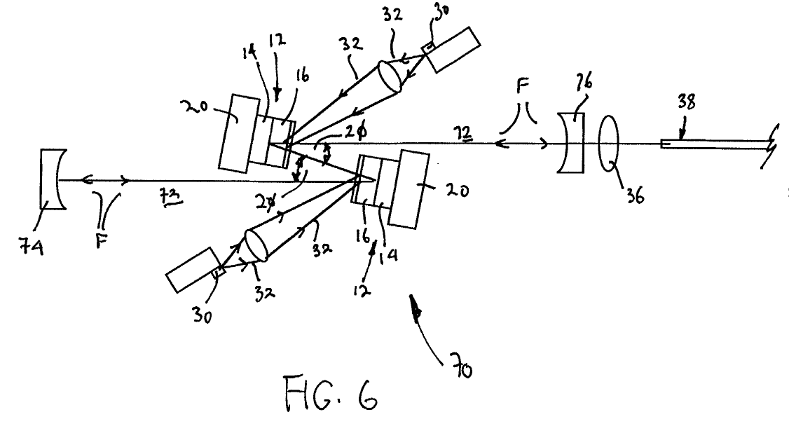

Referring now to FIG. 6 another preferred embodiment 70 of a laser in accordance with the present invention includes two OPS structures 12 in a resonator 72 terminated by a maximally reflecting mirror 74 and an output-coupling mirror 76. Resonator 72 is folded once by each of the OPS structures at an angle of 2Φ. This arrangement may be used to provide more optical gain than is provided in resonator 50 to FIG. 2, or to provide the same optical gain by reducing the pumping power and resultant thermal loading on the OPS structures. The fold angles may be the same or different provided that at least one of the fold angles is in the critical range. Preferably, both angles are in the critical range.

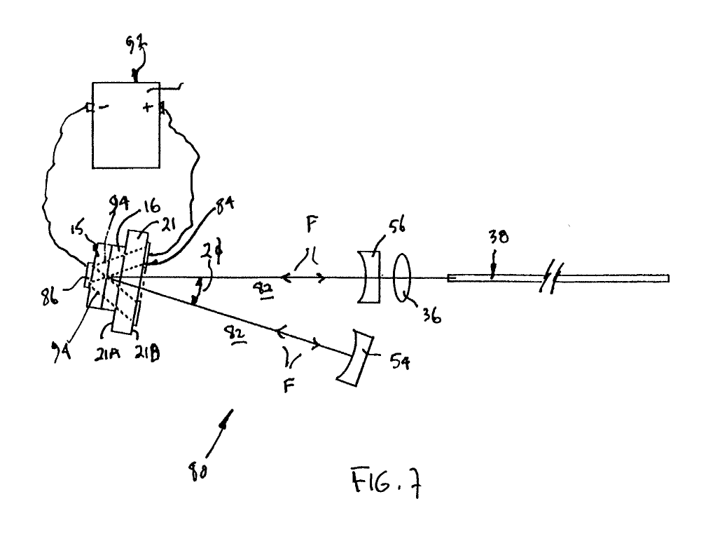

In FIG. 7, yet another preferred embodiment 80 a laser in accordance with the present invention is illustrated. Here, surface-emitting gain-structure 16 is grown on one surface 21A of an electrically conductive semiconductor substrate 21. The gain-structure is surmounted by a semiconductor Bragg-mirror structure 15 in electrical contact therewith. Laser 80 includes a folded resonator 82 terminated by a maximally reflecting mirror 54 and an output-coupling mirror 56. Resonator 82 is folded at an angle of 2Φ within the above-described critical range for multimode operation.

In electrical contact with surface 21B of substrate 21 is an annular electrode 84 (shown in diametric cross-section). A disk-shaped electrode 86 is in electrical contact with mirror structure 15. Electrodes 84 and 86 are connected by lines 88 and 90 respectively to a power supply a 92, causing current to flow through gain-structure 16 generally as indicated by dotted lines 94, for energizing the gain-structure. With gain-medium 16 thus electrically energized resonator 82 generates radiation in multiple axial modes. This embodiment has a disadvantage that substrate 21 is included in resonator 82. Optical losses in the substrate due to free-carrier absorption in the substrate can limit available output power.

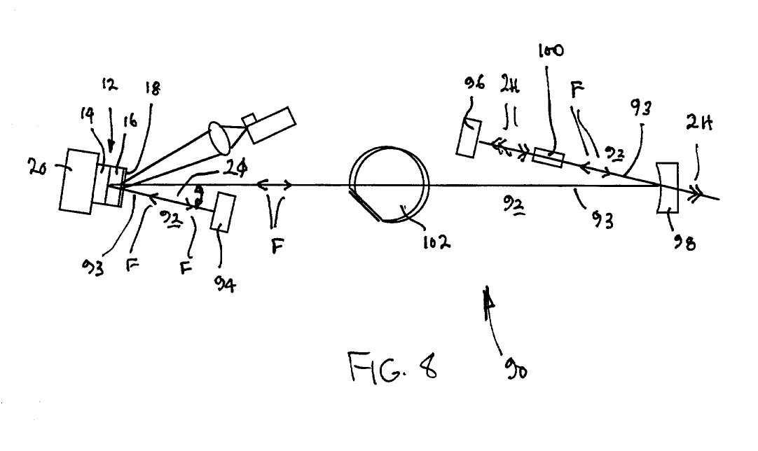

Referring now to FIG. 8, still another embodiment 90 of a laser in accordance with the present invention is illustrated. Laser 90 includes a laser resonator 92 terminated by plane mirrors 94 and 96. Longitudinal axis 93 of resonator 92 is folded by mirror structure 14 of an OPS structures 12 at an angle of 2Φ within the above-described critical range for multimode operation. This, as discussed above, provides that fundamental radiation F circulating in resonator 90 is in multiple axial modes. Resonator 92 is also folded at an angle by θ concave mirror 98. Fold angle θ is not critical, but is preferably kept to a minimum to minimize any astigmatism introduced by non-normal incidence of radiation F on mirror 98.

An optically nonlinear crystal 100 is is located in resonator 92 between mirrors 96 and 98. Optically nonlinear crystal 100 is arranged to double the frequency of fundamental radiation F, thereby generating second-harmonic radiation indicated by arrows 2H. A birefringent filter 102 is located in resonator 92 between mirror 96 and OPS-structure 12. The birefringent filter is used, inter alia, to select a particular wavelength of operation of laser 90 within the gain-bandwidth of gain-structure 16 of OPS-structure 12, and to polarize circulating radiation appropriate to a phase-matching arrangement of optically-nonlinear crystal 100. Those skilled in the art are familiar with such phase-matching arrangements for frequency conversion. Accordingly, a detailed description of these phase-matching arrangements is not presented herein.

Mirror 94 is preferably coated for maximum reflection at the fundamental wavelength. Mirror 96 is preferably coated for maximum reflection at the fundamental and second-harmonic wavelengths. Mirror 98 is preferably coated for maximum reflection at the fundamental wavelength and maximum transmission at the second-harmonic wavelength. Second harmonic radiation is delivered from laser 90 via mirror 98.

The frequency doubling arrangement of laser 90 is but one frequency conversion arrangement possible for a laser in accordance with the present invention. Arrangements including two optically-nonlinear crystals arranged for frequency tripling or frequency quadrupling are also possible. Details of a range of single mode OPS lasers in various frequency conversion arrangements are described in U.S. Pat. No. 5,991,318, the complete disclosure of which is hereby incorporated by reference.

The present invention has been described and depicted above in terms of a preferred and other embodiments. The invention is not limited, however, to the embodiments described in depicted. Rather, the invention is limited only by the claims appended hereto.

What is claimed is:

1. A laser, comprising:
a laser resonator terminated by first and second mirrors said laser resonator having a longitudinal axis;
a monolithic layer structure including a mirror structure in contact with a semiconductor multilayer surface-emitting gain-structure, said gain structure including a plurality of active layers spaced apart by spacer layers; and
an arrangement for energizing said gain-structure and causing laser radiation to be generated in said laser resonator, and wherein said longitudinal axis of said laser resonator is folded at a fold angle by said mirror structure of said monolithic layer structure with said gain-structure within said laser resonator, said fold angle being selected such that said laser radiation is generated in multiple axial modes.

2. The laser of claim 1, wherein said energizing arrangement is an arrangement for optically energizing said gain-structure.

3. The laser of claim 1, wherein said energizing arrangement is an arrangement for electrically energizing said gain-structure.

4. The laser of claim 1, wherein said monolithic layer structure is located in said laser resonator about midway between said first and second mirrors.

5. The laser of claim 4, wherein said fold angle is between 7 and 10 degrees.

6. The laser of claim 1, wherein said laser resonator further includes an optically-nonlinear crystal arranged to double the frequency of said laser radiation generated therein.

7. A system using the laser of claim 1 further including an optical fiber and a lens for focusing the laser radiation generated by the laser into the fiber.

8. A laser, comprising:
a laser resonator terminated by first and second mirrors said laser resonator having a longitudinal axis;
first and second monolithic layer structures, each thereof including a mirror structure in contact with a semiconductor multilayer surface-emitting gain-structure, said gain structure including a plurality of active layers spaced apart by spacer layers;
said longitudinal axis of said laser resonator being folded by said mirror structures of said monolithic layer structures at first and second angles;
an arrangement for energizing said gain structures and causing laser radiation to be generated in said laser resonator; and
wherein at least one of said first and second angles is selected such that said laser radiation is generated in multiple axial modes.

9. The laser of claim 8, wherein said first and second angles are equal.

10. A laser, comprising:
a laser resonator terminated by first and second mirrors said laser resonator having a longitudinal axis;
an electrically-conductive semiconductor substrate having a monolithic layer structure thereon, said monolithic layer structure including a semiconductor multilayer surface-emitting gain-structure surmounted by a mirror structure, said gain-structure including a plurality of active layers spaced apart by spacer layers;
said longitudinal axis of said laser resonator being folded at an angle by said mirror structure of said monolithic layer structure with said gain-structure and said substrate inside said laser resonator,
an arrangement for electrically energizing said gain-structure and causing laser radiation to be generated in said laser resonator; and
wherein said fold angle is selected such that said laser radiation is generated in multiple axial modes.

11. The laser of claim 10, wherein said electrical energizing arrangement includes a first electrode on said substrate and a second electrode on said mirror structure and an electrical power supply connected to said first and second electrodes said first and second electrodes arranged such that electrical current flows through said gain structure.

12. A laser, comprising:
a laser resonator terminated by first and second mirrors said laser resonator having a longitudinal axis;
a monolithic layer structure including a mirror structure in contact with a semiconductor multilayer surface-emitting gain-structure, said gain structure including a plurality of active layers spaced apart by spacer layers; and
an arrangement for directing optical pump light into said gain-structure and causing laser radiation to be generated in said laser resonator, and wherein said longitudinal axis of said laser resonator is folded at a fold angle by said mirror structure of said monolithic layer structure with said gain-structure within said laser resonator, said fold angle being selected such that said laser radiation being generated in multiple axial modes.

13. The laser of claim 12, wherein said monolithic layer structure is located in said laser resonator about midway between said first and second mirrors.

14. The laser of claim 13, wherein said fold angle is between 7 and 10 degrees.

15. The laser of claim 12, wherein said laser resonator further includes an optically-nonlinear crystal arranged to double the frequency of said laser radiation generated therein.

16. A system using the laser of claim 12 further including an optical fiber and a lens for focusing the laser radiation generated by the laser into the fiber.
